(19) United States
(12) Patent Application Publication
(10) Pub. No.: US 2008/0199642 A1
(43) Pub. Date: Aug. 21, 2008

(54) Molded Composite Slip Adapted for Engagement With an Internal Surface of a Metal Tubular

(76) Inventor: James Barlow, Oologah, OK (US)

Correspondence Address: RICHARD AUCHTERLONIE;NOVAK DRUCE & QUIGG, LLP, 1000 LOUISIANA, 53RD FLOOR, HOUSTON, TX, 77002, US

(21) Appl. No.: 11/676,231

(22) Filed: Feb. 16, 2007

(51) Int. Cl. B29D 22/00

(52) U.S. Cl. 428/34.5; 428/34.1; 428/35.7

(57) ABSTRACT

The gripping capability of a composite slip for a downhole zonal isolation tool is enhanced by applying high friction material to the outer surface of the composite slip. Preferably the high friction material is granular abrasive arranged in circumferential rows on the outer surface of the composite slip. The composite slip including the high friction material is easily formed by matched metal compression molding of epoxy fiberglass sheet molding compound. By molding circumferential grooves in the outer surface of the composite body of the slip, granular abrasive is easily bonded with epoxy adhesive to the composite slip body in order to form the rows of granular abrasive. It is also possible to embed the granular abrasive into the composite material of the slip when the composite slip is molded.

### FIELD OF THE INVENTION

The present invention relates to a composite slip adapted for engagement with an internal surface of a metal tubular.

### BACKGROUND OF THE INVENTION

Composite slips are used in downhole zonal isolation tools to hold the tool in place during stimulation and service work. For example, the zonal isolation tool is a bridge plug, frac plug, or packer for bridging a hole or gap of a metal tubular such as a well casing.

The zonal isolation tool has an internal elongated mandrel and a circular array of slips mounted on the mandrel at each end of the tool. Each slip has an outer surface adapted for engagement with the internal surface of the well casing. Each slip also has an inclined inner surface. Each array of slips is disposed next to a respective conical ring mounted on the mandrel for sliding under the inclined inner surfaces of the slips in the array. In the middle of the zonal isolation tool, rings of elastomeric sealing material are mounted on the mandrel between the conical rings. When a setting tool pulls the mandrel in the longitudinal direction, the rings of sealing material expand outward in the radial direction to seal the well casing. In addition, the conical rings slide under the slips and force the slips outward in the radial direction into engagement with the well casing. The slips lock the zonal isolation tool in place inside the well casing in such a way that the rings of sealing material remain in compression for sealing the well casing when the setting tool is removed.

The zonal isolation tool can be designed to be retrievable and reusable after it has been set in the well casing. However, the zonal isolation tool is most economical to manufacture when it has been constructed to become permanently set in the well casing so that it must be drilled out destructively to unseal the well casing. Traditionally, such a drillable zonal isolation tool has been made of a cast iron mandrel and cast iron slips.

A number of downhole tool makers have replaced the cast iron components of the zonal isolation tools with composite components of epoxy fiberglass. The composite components can be drilled out faster than cast iron, and the drilled-out chips of composite material are lighter than cast iron chips so that the composite chips are more easily flushed out of the tubular member with drilling fluid. The composite downhole tools are also lighter than the cast iron downhole tools and can be used in both high and low pH environments. Details of construction of such composite zonal isolation tools are found, for example, in Turley et al. U.S. Pat. No. 6,712,153, issued Mar. 30, 2004, incorporated herein by reference, and in Sutton et al., U.S. Pat. No. 6,976,534 issued Dec. 20, 2005, incorporated herein by reference.

As evident from the Turley et al. U.S. Pat. No. 6,712,153 and the Sutton et al. U.S. Pat. No. 6,976,534, there has been a problem when the metal slips of a zonal isolation tool have been replaced with composite slips. As shown in FIG. 1 of the Turley et al. U.S. Pat. No. 6,712,153, the outer surface of the metal slip can be formed with serrated teeth for engagement with the inner surface of the metal tubular member so as to immobilize the slip with respect to the metal tubular member. Fiberglass composite material formed with a similar shape has a very limited capability for gripping the inner surface of the metal tubular member. Sutton et al. U.S. Pat. No. 6,976,534 recognizes this problem and attempts to solve it by placing ceramic inserts or buttons in the composite slip in order to grip into the inner wall of the metal tubular member. The ceramic inserts create an initial penetration of the well casing during the setting procedure and hold the zonal isolation tool in place during the service job. The ceramic inserts are easy to drill out with the slips when the tool is destructively removed from the well casing. However, the ceramic inserts tend to chip, especially when they are set in the well casing, which can compromise the gripping action of the slip elements. Therefore Sutton et al. U.S. Pat. No. 6,976,534 proposes that some of the ceramic inserts should be replaced with inserts made of a metallic/ceramic composite material that is stronger and less susceptible to chipping.

### SUMMARY OF THE INVENTION

It is desired to increase the gripping capability of a composite slip adapted for engagement with an internal surface of a metal tubular. It is also desired to provide a more economical manufacturing process resulting in a composite slip having more uniform and desirable characteristics.

The gripping capability of the composite slip has been limited by the holding capability of the ceramic inserts and the coefficient of friction between the outer surface of the composite slip and the inner wall of the well casing. The ceramic inserts are limited in number and in strength. The ceramic inserts are of a brittle nature, subject to chipping and cracking. The ceramic inserts are inserted in cavities in the composite slip, and these cavities are weak regions where the composite material may break and lose contact with the inner wall of the casing. In practice, the ceramic inserts deform and penetrate the casing so that the outer surface of the slip is in load-bearing contact with the inner wall of the casing. Yet the coefficient of friction between the composite material and the metal of the casing is relatively low, especially in the wet environment of a well bore.

In accordance with one aspect, the invention provides a composite slip. The composite slip includes a body of composite material. The body has an outer surface adapted for engagement with an internal surface of a metal tubular. The composite slip also includes high friction material that is secured to the body and disposed at and distributed over the outer surface of the body for gripping the internal surface of the metal tubular.

In accordance with another aspect, the invention provides a composite slip. The composite slip includes a body of composite material including glass or ceramic fiber in a matrix of thermoset polymer. The body has an outer surface adapted for engagement with an internal surface of a metal tubular. The composite slip further includes granular abrasive that is secured to the body, disposed at the outer surface of the body, and distributed over the outer surface of the body in rows for gripping the internal surface of the metal tubular.

In accordance with yet another aspect, the invention provides a composite slip. The composite slip includes a body of epoxy-fiberglass material. The body has an outer surface adapted for engagement with an internal surface of a metal tubular. The body has spaced grooves in the outer surface. The composite slip also includes ceramic or metal/ceramic composite inserts disposed in cavities in the body and protruding from the outer surface of the body for penetration of the internal surface of the metal tubular. The composite slip further includes granular abrasive disposed in the spaced grooves and protruding from the outer surface of the body. The granular abrasive is bonded to the body by epoxy adhesive in the grooves, and the granular abrasive is distributed in rows over the outer surface of the body between and around the inserts.

The high friction material, for example, is granular abrasive such as steel particles, crushed ceramic, or crushed crystalline material. The granular abrasive, for example, is aluminum oxide, zirconium oxide, tungsten carbide, silicon carbide, silicon dioxide, or crushed granite. The granular abrasive, for example, is bonded to the composite material of the composite slip by being embedded in the composite material, or by being bonded to the composite material by a bonding agent such as epoxy adhesive or rubber.

Preferably the high friction material is very well sorted (i.e., phi under 0.35) coarse or very coarse (i.e., grain size of from 0.5 mm to 2.0 mm) granular aluminum oxide abrasive arranged in circumferential rows on the outer surface of the composite slip. For example, the granular abrasive is disposed in rows by forming the composite material with circumferential grooves in the outer surface of the slip, filling the grooves with bonding agent, and then pouring the granular abrasive over the outer surface of the slip, so that the granular abrasive that falls in the grooves becomes bonded to the composite slip. Alternatively, a mold for the composite slip has a wall defining the outer surface of the composite slip, the wall is formed with circumferential grooves, and the granular abrasive is laid up in the grooves of the mold prior to molding of the composite slip so that the granular abrasive becomes imbedded in and bonded to the composite material in ridges on the outer surface of the composite slip during the molding of the composite material.

By forming cavities for the ceramic inserts during the molding process, the weak regions around the cavities are much stronger than if the cavities were machined after the molding process. Machining of the cavities would sever the fibers of the composite material precisely at the regions of high stress where continuous fiber is needed. By charging the mold with a glass-epoxy pre-mix sheet molding compound, it is possible to mold a suitable composite slip that requires no machining other than removal of flashing at the mold piece parting line.

An unexpected benefit of the high friction material on the surface of the composite slip is that it holds the composite slip surface in engagement with the well casing wall even if the slip would break up at the weak regions around the ceramic insert cavities.

### BRIEF DESCRIPTION OF THE DRAWINGS

Additional features and advantages of the invention will be described below with reference to the drawings, in which:

FIG. 1 is a lateral cross-section of a bridge plug tool and a setting tool in a well casing prior to setting of the bridge plug tool;

FIG. 2 shows the bridge plug tool and the setting tool of FIG. 1 once the bridge plug tool has been set within the well casing;

FIG. 3 shows a cross-section of an array of slips along line 3-3 in FIG. 2;

FIG. 4 is an isometric view of a slip;

FIG. 5 is a cross-section along line 5-5 in FIG. 4;

FIG. 6 shows a front view of the slip body just after it has been molded in accordance with a first method of manufacture;

FIG. 7 shows a lateral cross-section of the mold producing the slip body as shown in FIG. 6;

FIG. 8 shows a transverse cross-section of the mold of FIG. 7 showing how the mold is charged with a roll of sheet molding compound;

FIG. 9 shows a lateral cross-section of the outer surface of the slip body of FIG. 6 after bonding of granular abrasive;

FIG. 10 shows a second method of manufacture for the slip; and

FIG. 11 shows a lateral cross-section of the outer surface of a slip manufactured using the second method of FIG. 10.

While the invention is susceptible to various modifications and alternative forms, specific embodiments thereof have been shown in the drawings and will be described in detail. It should be understood, however, that it is not intended to limit the invention to the particular forms shown, but on the contrary, the intention is to cover all modifications, equivalents, and alternatives falling within the scope of the invention as defined by the appended claims.

### DETAILED DESCRIPTION OF THE PREFERRED EMBODIMENT

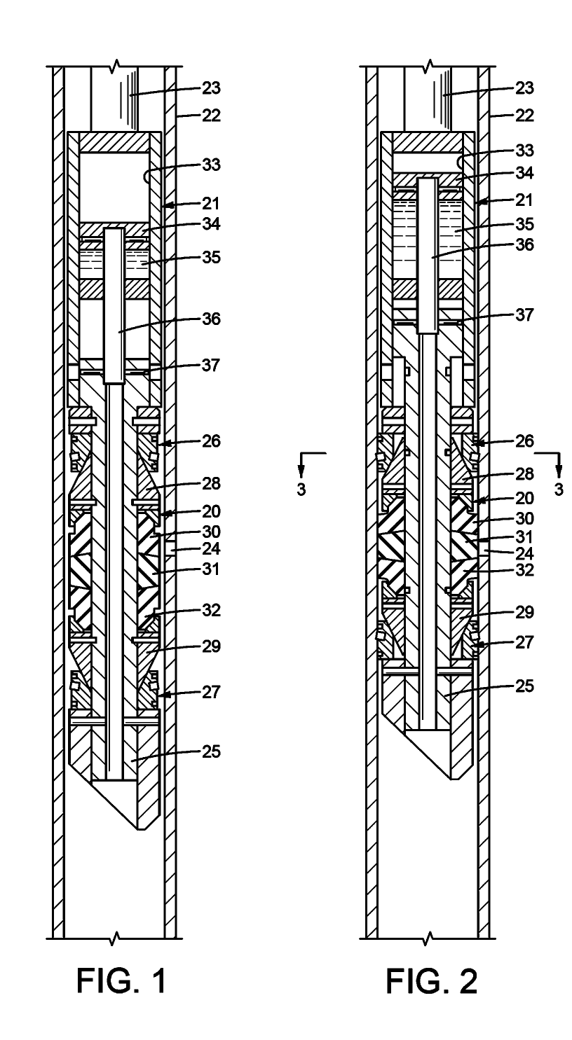

With reference to FIG. 1, there is shown a lateral cross-section of a bridge plug tool 20 and a setting tool 21 in a well casing 22 prior to setting of the bridge plug tool. For example, the bridge plug tool 20 and the setting tool 21 are lowered by a conduit 23 into the well casing 22 in order to seal a perforation 24 in the well casing 22.

The bridge plug tool 20 has an internal elongated mandrel 25 and a respective circular array of slips 26, 27 mounted on the mandrel at each end of the bridge plug tool. Each slip has an outer surface adapted for engagement with the internal surface of the well casing 22. Each slip also has an inclined inner surface. Each array of slips 26, 27 is disposed next to a respective conical ring 28, 29 mounted on the mandrel 25 for sliding under the inclined inner surfaces of the slips in the array. In the middle of the sealing tool, rings 30, 31, 32 of elastomeric sealing material are mounted on the mandrel between the conical rings 28, 29.

Once the bridge plug tool 20 has been aligned with the perforation 24, the setting tool 21 is activated. For example, the setting tool 21 has a cylinder 33 and a piston 34 driven by fluid 35 under pressure, such as hydraulic fluid or gas generated by a pyrotechnic charge. The piston 34 has a shaft 36 coupled by a shear pin 37 to the mandrel 35 for pulling the mandrel in the longitudinal direction.

As shown in FIG. 2, when the piston 34 of the setting tool 21 pulls the mandrel 35 of the bridge plug tool 20, the rings 30, 31, and 32 of sealing material expand outward in the radial direction to seal a zone of the well casing 22. In addition, the conical rings 28, 29 slide under the arrays of slips 26, 27 and force the slips outward in the radial direction into engagement with the inner wall of the well casing 22. The slips lock the bridge plug tool 20 in place inside the well casing 22 in such a way that the rings of sealing material 30, 31, 32 remain in compression for sealing the perforation 24 in the well casing when the setting tool 21 is removed. For example, continued motion of the piston 34 causes the pin 37 to shear, so that the bridge plug tool 20 becomes uncoupled from the setting tool 21. Then the conduit 23 pulls the setting tool 21 out from the well casing 22.

If later it is desired to remove the bridge plug tool 20 from the well casing 22, then the bridge plug tool is drilled out destructively. For fast drill-out, light weight, and tolerance of high and low pH environments, the bridge plug tool 20 is comprised of composite material such as epoxy fiberglass. For example, the epoxy resin is a 50:50 blend by weight of a cycloaliphatic epoxy resin and an epoxy resin of bisphenol A and epichlorohydrin.

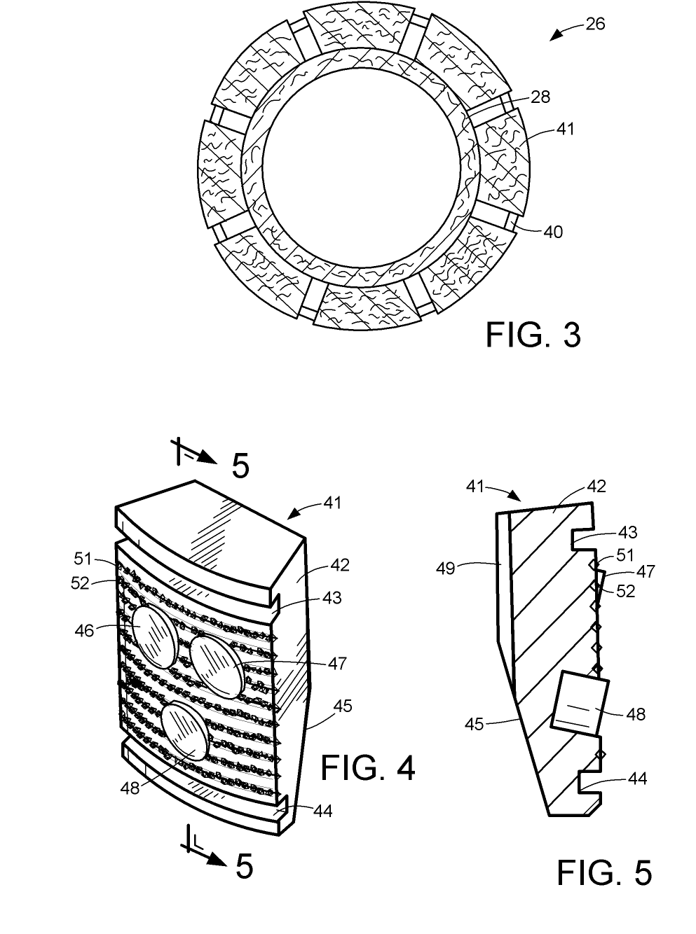

FIG. 3 shows a cross-section of the circular array 26 of eight slips upon the conical ring 28. Each slip has the same construction. An elastomeric “O” ring 40 retains the slips against the conical ring 28.

FIG. 4 shows one of the slips 41 in further detail. The slip 41 has a body 42 of composite material. The outer face of the slip body 42 is cylindrical and has a radius of curvature matching the radius of the inner wall of the well casing (22 in FIG. 1). The outer face of the slip body 42 is formed with two arcuate slots 43, 44. Each arcuate slot 43, 44 is sized for receiving an elastomeric “O” ring (e.g., the ring 40 in FIG. 3). For gripping the inner wall of the well casing, two ceramic buttons 46, 47 and one metallic/ceramic composite button 48 are disposed in cavities in the outer face of the slip body 42.

For enhanced gripping of the inner wall of the well casing, the outer surface of the slip body 42 includes high friction material in addition to the ceramic or metal/ceramic buttons 46, 47, 48. Preferably this high friction material includes granular abrasive distributed around and between the buttons 46, 47, 49 and arranged in circumferential rows 51, 52. Thus, the rows granular abrasive are perpendicular to the longitudinal force applied to the mandrel by the setting tool, so that the composite material of the slip body 42 is most effective in applying this longitudinal force to the granular abrasive particles when the granular abrasive engages the inner wall of the well casing.

In practice, the ceramic and metal/ceramic buttons 46, 47, 48 deform and penetrate the inner wall of the casing so that the outer surface of the slip is in load-bearing contact with the inner wall of the casing. If the well casing has normal properties so that it is deformed by the ceramic and metal/ceramic buttons, then the outer surface of the slip including the abrasive material is pressed into the inner wall of the well casing with about 6,000 to 8000 psi. Therefore it is possible to significantly increase the holding capability of the slip under normal conditions. Under abnormal conditions, such as a fracture of the ceramic buttons or a fracture of the weak area of the composite slip around the buttons, the pressing of the abrasive material into the inner wall of the well casing may prevent a failure of setting of the zonal isolation tool that would require considerable service downtime to drill-out the defective tool from the well casing and insert a new tool.

For example, the slip body 42 has a size of about 1.3 inches by 1.85 inches by 0.6 inches, and ten rows of abrasive particles are disposed on the outer face of the slip between the arcuate grooves 43, 44, so that the center-to-center spacing between adjacent rows is about 0.12 inches. Preferably the abrasive grains are very well sorted (under 0.35 phi, i.e., the base two logarithm of the ratio of the standard deviation of grain size to the mean grain size is less than 0.35). Preferably the abrasive grains are coarse or very coarse (i.e., grain size of from 0.5 mm to 2.0 mm). Preferably the abrasive grains are comprised primarily of aluminum oxide. For example, the abrasive grains are obtained by sorting very coarse crushed aluminum oxide industrial abrasive (generally known as “brown aluminum oxide”) with a U.S. Standard Sieve Mesh No. 18 to remove any particles with a size less than 1.0 mm, and then sorting the remaining grains with a U.S. Standard Sieve Mesh No. 16 to obtain grains with a size between 1.0 mm and 1.2 mm. The larger grains are crushed and sorted again.

As shown in FIG. 5, the slip body 42 is formed with a conical back surface 45 matching the outer conical surface of the conical ring (28 in FIG. 3), and a cylindrical back surface 49 matching the outer cylindrical surface of the mandrel (25 in FIG. 2).

The granular abrasive can be disposed in rows at the outer surface of the composite body of the slip after the composite body of the slip is molded, or during the molding of the composite body of the slip. The most convenient method is to form circumferential grooves in the composite body of the slip during molding of the composite body of the slip, and after the composite body of the slip has been molded, then filling the circumferential grooves with a bonding agent, and then pouring the granular abrasive over the outer surface of the slip body so that granular abrasive that falls in the grooves becomes bonded to the composite slip. The less convenient method is to embed the granular abrasive into the composite body of the slip when the composite slip is molded.

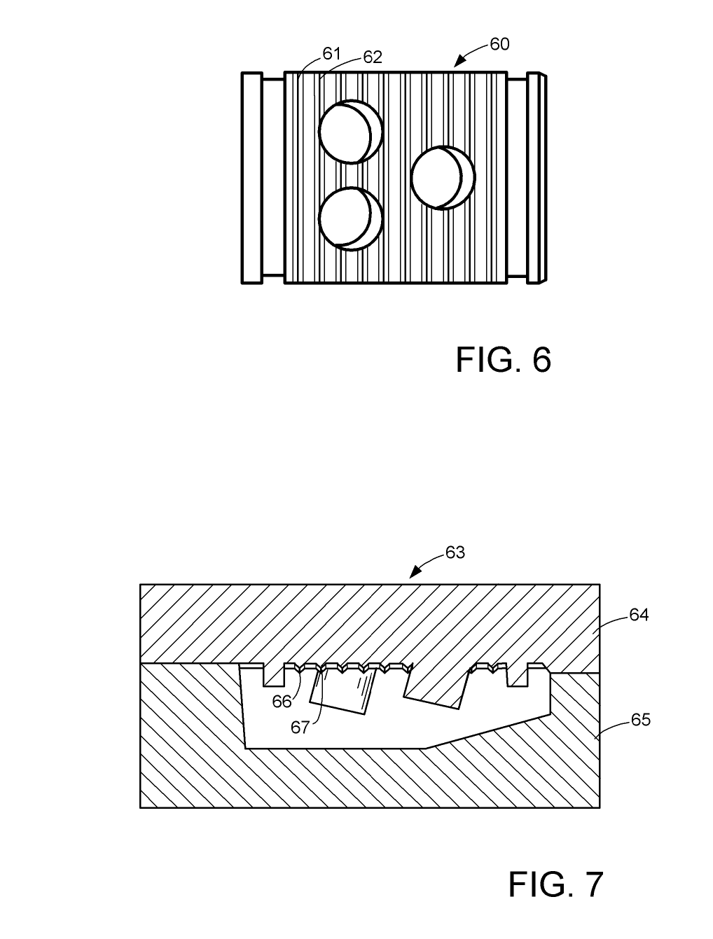

FIG. 6 shows a composite body 60 having circumferential grooves 61, 62 formed by a mold 63 of FIG. 7. For receiving granular abrasive having a grain size from 1.0 to 1.2 mm, the grooves are right angle V-shaped in cross section and have a depth of about 0.0625 inches. The mold 63 in FIG. 7 is a metal match mold for compression molding and has an upper piece 64 and a lower piece 65. The upper piece 64 has ridges 66, 67 for forming the circumferential grooves 61, 62.

FIG. 8 shows charging of the mold 63 with epoxy fiberglass sheet molding compound having chopped glass fiber laid down with random orientation. Preferably the sheet molding compound is LYTEX 9063 (Trademark) sheet molding compound obtained from Quantum Composites Inc., 1310 South Valley Center Drive, Bay City, Mich., 48706. LYTEX 9063 sheet molding compound contains 63 weight percent of 1″ chopped glass fiber and 37 weight percent of epoxy resin compound. The glass fiber diameter is 13 microns. The epoxy resin compound is formulated with bisphenol A type epoxy resin, acid anhydride hardener and additives. A strip of the sheet molding compound is wrapped into a seven layer roll, and placed in the mold, and compression molded at about 4000 psi pressure at a temperature of about 300-310 degrees Fahrenheit for twelve minutes. The mold is overcharged with the sheet molding compound 68 so that about 8% of the charge is squeezed out of the mold between the two pieces 64, 65 of the mold. When the slip body 60 is removed from the mold, the only required machining is grinding off flashing at the parting line.

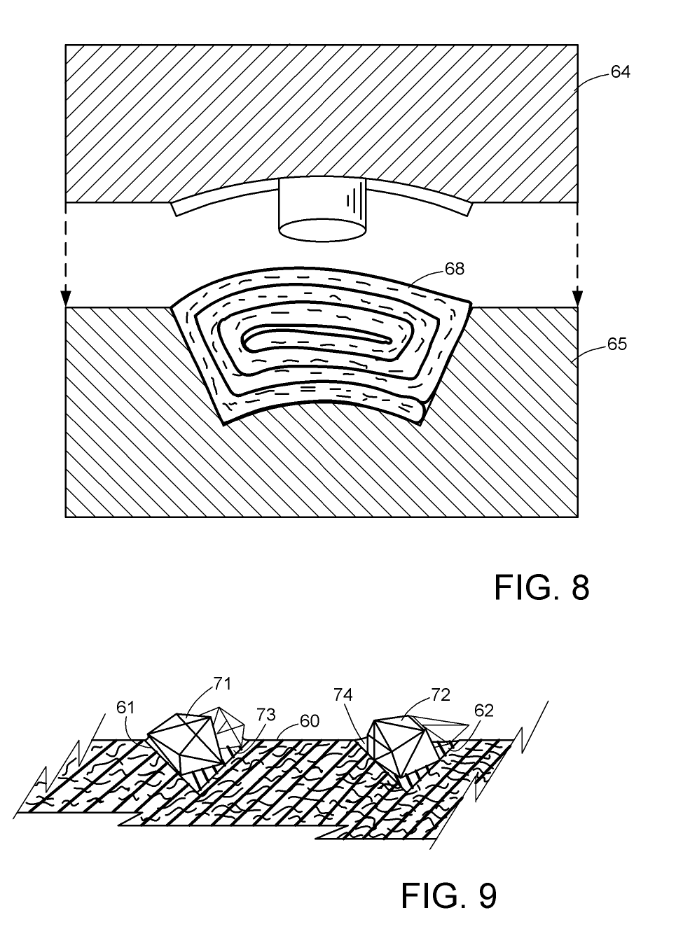

FIG. 9 shows abrasive grains 71, 72 disposed in the grooves 61, 62 and bonded by epoxy adhesive 73, 74 to the slip body 60. The ceramic buttons (46, 47, and 48 in FIG. 5) can be glued into their respective cavities at the same time using the same kind of epoxy adhesive. For example, the adhesive is obtained by mixing equal volumes of Lord Corporation 310-A epoxy resin and Lord Corporation 310-B epoxy hardener from Lord Corporation at 111 Lord Drive, Cary, N.C. 27511. A rubber squeegee or polyethylene blade is used to wipe the epoxy adhesive off the outer surface of the composite slip body while filling the circumferential grooves with epoxy adhesive, and then the ceramic buttons are inserted into their respective cavities, and then granular abrasive is poured over the entire outer surface of the composite slip body. Once the epoxy adhesive has hardened, any granular abrasive that is not located in the circumferential grooves and that may be stuck to the slip is removed with a wire brush. For increased adhesive bond strength, the finished composite slip is given a final cure at elevated temperature, for example, at 250 degrees Fahrenheit for one hour.

The molded LYTEX 9063 sheet molding compound is sufficiently compliant that there is no need for the adhesive 73, 74 to be compliant or toughened. If the composite slip body were made of a relatively non-compliant material such as a glass phenolic composite, then it may be desirable to use a compliant or toughened adhesive, or incorporate a near-surface layer of compliant material in the composite slip body, in order to ensure substantially uniform pressing of the granular abrasive into the inner wall of the well casing. For example, epoxy adhesive can be toughened by incorporating ground rubber powder into the adhesive.

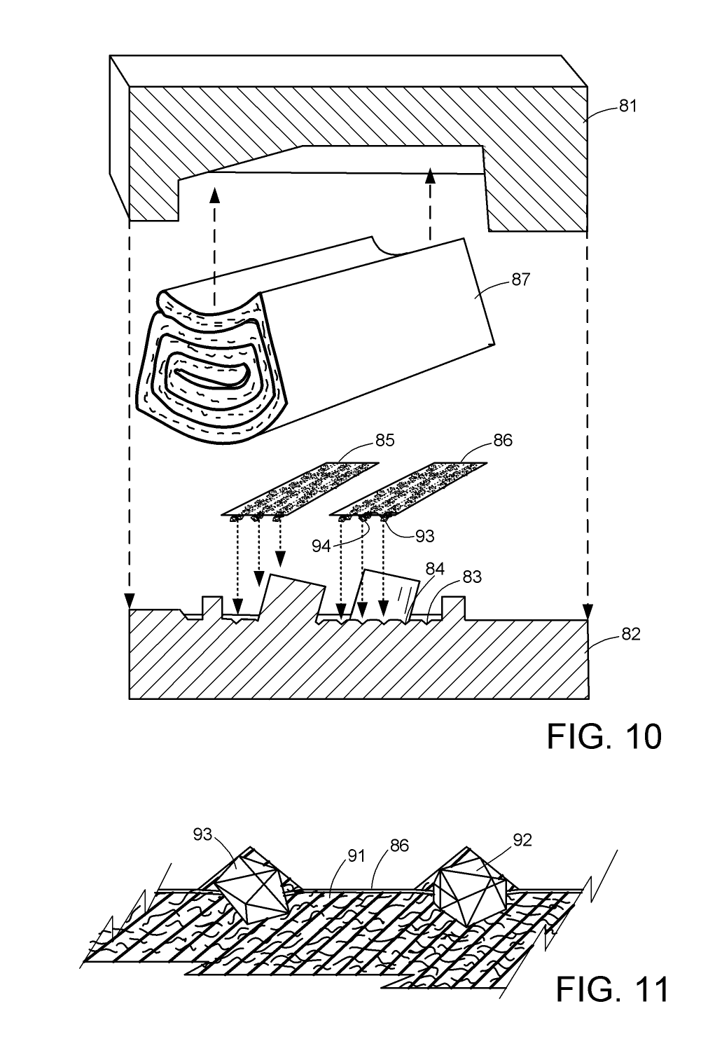

FIG. 10 shows a method of embedding the granular abrasive into the composite body of the slip when the composite body of the slip is molded. In this example, a metal mold with two pieces 81, 82 is again used, but the piece 82 has circumferential grooves 83, 84 instead of circumferential ridges for locating the granular abrasive in rows at the outer surface of the composite slip. The granular abrasive, for example, is first lined up and bonded in rows on strips 85, 86 of sheet material such as woven fiberglass, or if a compliant near surface layer is desired in the composite slip, on a compliant material such as polyaramid cloth or raw calendared nitrile rubber. The granular adhesive can be bonded to the woven fiberglass using the same kind of epoxy as is used in the sheet molding compound. The granular abrasive can be bonded to rubber sheet strips by an adhesive such as Lord Corporation TYPLY BN adhesive or Lord Corporation CHEMLOCK 205 adhesive from Lord Corporation at 111 Lord Drive, Cary, N.C. 27511.

Once strips 85, 96 for all the granular abrasive are laid over and aligned with the circumferential grooves in the mold piece 82, a roll 87 of sheet molding compound is laid over the strips and while being partially stuffed into the cavity of other mold piece 87, and then the mold pieces are brought together, and the part is compression molded.

FIG. 11 shows the embedding of the abrasive grains 92, 93 in the composite slip resulting from the molding process of FIG. 10. The abrasive grains 82, 93 become disposed in spaced ridges on the outer surface of the composite slip. In FIG. 11, the sheet material of the strip 86 is included in a near surface layer of the composite slip body 91. By using a rather open weave of fiberglass cloth, the abrasive grains 92, 92 may penetrate the cloth and also the chopped glass fiber as well as the resin of the sheet molding compound may penetrate the cloth so that most of each grain of abrasive is embedded in the epoxy fiberglass matrix of the sheet molding compound. However, by using multiple near surface layers of compliant material such as polyaramid cloth or rubber, it would also be possible to provide a compliant or resilient buffer between the abrasive grains and the bulk composite material of the composite slip.

In view of the above, the gripping capability of a composite slip is enhanced by providing high friction material to the outer surface of the composite slip in addition to the ceramic and metallic/ceramic composite inserts that are typically used in composite slips. Preferably the high friction material is granular abrasive arranged in circumferential rows on the outer surface of the composite slip. The high friction material is especially useful if the ceramic inserts fracture or there is a fracture of the relatively weak and highly stressed region of the composite slip near the metallic/ceramic composite insert. Granular abrasive is particular effective for engagement with the inner wall of a metal tubular that does not deform in the fashion typical of well casing or that has a surface hardness greater than the surface hardness typical of well casing so that the ceramic or metallic/ceramic composite inserts would be ineffective for setting of the zonal isolation tool.

The composite slip including the high friction material is easily formed body. It is also possible to embed the granular abrasive into the composite material of the slip when the composite slip is molded.

What is claimed is:

1. A composite slip comprising:
a body of composite material, the body having an outer surface adapted for engagement with an internal surface of a metal tubular; and
high friction material secured to the body and being disposed at and distributed over the outer surface of the body for gripping the internal surface of the metal tubular.

2. The composite slip as claimed in claim 1, wherein the composite material includes glass or ceramic fiber in a matrix of thermoset polymer.

3. The composite slip as claimed in claim 1, wherein the composite material consists essentially of randomly-oriented glass fibers in an epoxy matrix.

4. The composite slip as claimed in claim 1, wherein the high friction material is granular abrasive.

5. The composite slip as claimed in claim 1, wherein the high friction material is selected from the group consisting of steel particles, crushed ceramic, and crushed crystalline material.

6. The composite slip as claimed in claim 1, wherein the high friction material is granular abrasive material, the abrasive material being selected from the group consisting of aluminum oxide, zirconium oxide, tungsten carbide, silicon carbide, silicon dioxide, and crushed granite.

7. The composite slip as claimed in claim 1, wherein the high friction material is granular abrasive having a grain size of from 0.5 mm to 2.0 mm.

8. The composite slip as claimed in claim 1, wherein the high friction material is granular abrasive having a grain size, the grain size having a mean value and a standard deviation such that the base two logarithm of the ratio of the standard deviation to the mean value is less than 0.35.

9. The composite slip as claimed in claim 1, which further includes ceramic or metal/ceramic composite inserts disposed in cavities in the body and protruding from the outer surface of the body for penetration of the internal surface of the metal tubular, wherein the high friction material is distributed over the surface of the body around and between the inserts.

10. The composite slip as claimed in claim 1, wherein the high friction material is granular abrasive arranged in rows over the outer surface of the body.

11. The composite slip as claimed in claim 1, wherein the body has spaced grooves in the outer surface of the body, and the high friction material is granular abrasive disposed in the grooves and bonded to the body by adhesive in the grooves.

12. The composite slip as claimed in claim 1, wherein the outer surface of the body is formed with spaced ridges, and the high friction material is granular abrasive disposed in the spaced ridges.

13. The composite slip as claimed in claim 1, wherein the high friction material is granular abrasive, and the composite slip further includes compliant material disposed between the granular abrasive and the composite material of the body.

14. The composite slip as claimed in claim 13, wherein the compliant material includes elastomer.

15. The composite slip as claimed in claim 13, wherein the compliant material includes at least one sheet disposed in a layer of the body near the outer surface of the body.

16. The composite slip as claimed in claim 1, wherein the high friction material is granular abrasive, and the granular abrasive is embedded in the composite material of the body.

17. A composite slip comprising:
a body of composite material, the composite material including glass or ceramic fiber in a matrix of thermoset polymer, the body having an outer surface adapted for engagement with an internal surface of a metal tubular; and
granular abrasive secured to the body and disposed at the outer surface of the body and distributed over the outer surface of the body in rows for gripping the internal surface of the metal tubular.

18. The composite slip as claimed in claim 17, wherein the composite material consists essentially of randomly-oriented glass fibers in an epoxy matrix.

19. The composite slip as claimed in claim 17, wherein the granular abrasive consists primarily of aluminum oxide.

20. The composite slip as claimed in claim 17, wherein the granular abrasive has a grain size from about 1.0 to 1.2 mm.

21. The composite slip as claimed in claim 17, which further includes ceramic or metal/ceramic composite inserts protruding from the outer surface of the body for penetration of the internal surface of the metal tubular, wherein the granular abrasive is distributed around and between the inserts.

22. The composite slip as claimed in claim 17, wherein the body is formed with spaced grooves in the outer surface of the body, and the granular abrasive is disposed in the grooves and bonded to the body by adhesive in the grooves.

23. A composite slip comprising:
a body of epoxy-fiberglass material, the body having an outer surface adapted for engagement with an internal surface of a metal tubular, the body having spaced grooves in the outer surface;
ceramic or metal/ceramic composite inserts disposed in cavities in the body and protruding from the outer surface of the body for penetration of the internal surface of the metal tubular, and
granular abrasive disposed in the spaced grooves and protruding from the outer surface of the body, the granular abrasive being bonded to the body by epoxy adhesive in the grooves, and the granular abrasive being distributed in rows over the outer surface of the body between and around the inserts.

24. The composite slip as claimed in claim 23, wherein the granular abrasive consists primarily of aluminum oxide.

25. The composite slip as claimed in claim 23, wherein the granular abrasive has a grain size from about 1.0 to 1.2 mm.
